(19) United States
(12) Patent Application Publication
(10) Pub. No.: US 2011/0027404 A1
(43) Pub. Date: Feb. 3, 2011

(54) MULTI-TUBE EXTRUSION APPARATUS AND METHOD

(75) Inventors: Aamir W. Siddiqui, Naperville, IL (US); George O. Pehr, Orland Park, IL (US); Myron D. Nicholson, Lemont, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: VISKASE COMPANIES, INC., Darien, IL (US)

(21) Appl. No.: 12/893,451

(22) Filed: Sep. 29, 2010

Related U.S. Application Data
(62) Division of application No. 12/501,627, filed on Jul. 13, 2009.
(60) Provisional application No. 61/080,467, filed on Jul. 14, 2008.

(51) Int. Cl. B29C 47/20

(52) U.S. Cl. 425/377

(57) ABSTRACT

A method and apparatus for producing a plurality of bi-oriented, heat-shrinkable thermoplastic tubular films is disclosed. Thermoplastic resin is extruded through a plurality of annular dies to form a plurality of molten plastic tubes. The tubes are cooled and solidified and sent through a plurality of pinch rollers to stretch the tubes simultaneously in a machine and transverse direction, creating a plurality of tubular films. The films are cooled and heated, and then relaxed simultaneously in a machine and transverse direction. Winding rollers then wind up the finished tubular films.

### CROSS REFERENCE TO RELATED APPLICATIONS

This application is a divisional of U.S. patent application Ser. No. 12/501,607 filed on Jul. 13, 2009, which claims priority to provisional application Ser. No. 61/080,467 filed on Jul. 14, 2008, which are herein incorporated by reference in their entirety.

### FIELD

This application relates to a method and apparatus for producing a plurality of bi-oriented, heat-shrinkable thermoplastic tubular films.

### BACKGROUND

It has been widely practiced as a packaging and processing technique for content materials, inclusive of foods such as raw meat, ham and sausage, principally, and other products, to form a casing, such as a bag or a pouch, from a heat-shrinkable multilayer film, and then fill the casing with such a content material, or to automatically package such a content material per se or a tray loaded with such a content material while simultaneously forming a casing from a heat-shrinkable multilayer film. Tubular films are used as sausage casings for processing and packaging cooked sausages including water cooked or steam cooked sausages such as liver sausage and fleischwurst or cheese sausage (cheese packed in the shape of a sausage).

It is generally known that selection of films for packaging food products such as meat and cheese sausages includes consideration of one or more criteria such as cost, abrasion resistance, wrinkle resistance, meat adhesion, dimensional uniformity and stability, stiffness, strength, printability, durability, oxygen and water barrier properties, stretchability, machinability, optical properties such as haze, gloss and freedom from streaks and gels, and safety for contact with food.

Desirably, casings for these types of sausages will also have low oxygen permeability to avoid discoloration, adverse flavor changes and oxidation of the sausage during storage. Liver sausage in particular is easily susceptible to defects when contacted with excessive oxygen and discoloration causing an unappetizing appearance which may be a particularly acute problem for this product.

Furthermore, it is highly desirable to produce an encased cooked sausage which exhibits a tight fitting casing having few or no wrinkles even after prolonged storage. There should be a minimum of spaces or pockets between the sausage mass and the inside of the casing since such spaces or pockets promote separation and collection of fats, liquid and gelatinous materials in such spaces which leads to a non-uniform sausage appearance which is unappetizing and undesirable to consumers.

Cellulose casings of, e.g., fiber reinforced regenerated cellulose coated with moisture barrier coatings such as a polyvinylidene chloride copolymer (PVDC), e.g. saran, have been commercialized as have monolayer casings made of polyvinylidene chloride copolymers such as saran. These casings have excellent oxygen and moisture barrier properties.

Commercially available coated cellulosic casings have excellent dimensional uniformity and stability, but are expensive to produce compared to plastic casings. The use of polyvinylidene chloride copolymers such as saran has raised environmental concerns due to the difficulties of recycling chlorinated polymers and possible release of chlorinated by-products during incineration. Furthermore, the dimensional stability and uniformity of saran monolayer casings are generally inferior to the cellulosic casings, and saran monolayer casings after cooking and chilling tend to relax causing a wrinkled appearance.

Thus, plastic casings made of various types of plastic, such as Polyamide, Polyester, and Polyethylene, have begun to replace the cellulose casings in the industry. Although plastic casing products have gained varying degrees of commercial acceptance in different market segments, their advantage compared to the traditional cellulosic casing has been chiefly one of cost with the problems of dimensional stability, uniformity of diameter, and wrinkling being persistent concerns.

Prior art fiber reinforced cellulose casings coated with moisture barrier coatings perform well in processing water/steam cooked sausages such as fleischwurst and liver sausage. However, the high cost of manufacture of such casings has led casing manufacturers to search for less expensive alternatives. Thermoplastic films of various compositions have been suggested and some have found varying degrees of success in various segments of the market. Thermoplastic sheet film has been made into a tube by seaming, but this is a difficult process which produces a casing having a seamed area which may undesirably differ in appearance and performance relative to an unseamed casing.

Seamless tubular thermoplastic casings have been made which overcome the objections to seamed casings. Various materials have been employed, but materials containing chlorinated polymers have been objected to for environmental reasons among others. Seamless polyamide casings have been made by a blown film process, however these casings tend to have poor performance with respect to wrinkling, uniformity of diameter, and dimensional stability. Seamless biaxially oriented multilayer films have also been made, such as disclosed in U.S. Pat. No. 6,565,985, which is also assigned to Viskase Corporation. The films may be monolayer or multilayer films.

A disadvantage of the current method and apparatus for making thermoplastic tubular films is that only one film can be produced at a time. Although the prior art machine is run at a very fast speed so that as many films can be produced as possible, the process is still very tedious and some necessary operations such as inflation cannot be done at high speed. Therefore, it would be better to run multiple strands at slower speeds. There is no known method or apparatus for producing a plurality of thermoplastic films at once.

It would be desirable to create a machine that can produce more than one tubular film simultaneously using multiple extruders, such as is currently done with cellulose casings, to save time, and to produce a greater amount of films with the lowest cost. It may be advantageous to produce a plurality of casings of the same size at a slower rate to allow time for melting, annealing, and key crystallization steps to occur. If the single position machine is run as fast as possible to meet economic criteria, a multiple position machine may run slower, at a higher quality and less waste, thus superseding the actual output of the ‘fast machines’.

### SUMMARY

The present application provides a method and apparatus for producing a plurality of bi-oriented, heat-shrinkable thermoplastic tubular films at once. In one embodiment, the apparatus comprises at least one extruder having a plurality of annular dies, a system for cooling and solidifying, a heat source, a first pair of pinch rollers, a second pair of pinch rollers, and a third set of pinch rollers. The second pair of pinch rollers pull a plurality of solid tubes forward towards the third set of pinch rollers, while introducing air into each of the solid tubes and then closing off the third set of pinch rollers to entrap the air in a length of the solid tubes, thereby biaxially stretching each tube simultaneously in each of a machine direction (MD) and transverse direction (TD) to form a plurality of bi-oriented tubular films.

The apparatus further includes at least one first cooling device placed between the second and third pairs of pinch rollers, and at least one second cooling device placed between a fourth pair of pinch rollers, and a fifth set of pinch rollers. The fourth pair of pinch rollers pull cooled bi-oriented tubular films forward towards the fifth set of pinch rollers, while introducing air into each of the cooled bi-oriented tubular films and then closing off the fifth set of pinch rollers to entrap the air in a length of the cooled bi-oriented tubular films, thereby biaxially relaxing each film simultaneously in each of a machine direction (MD) and transverse direction (TD) to form a plurality of tubular films which are smaller than the plurality of bi-oriented tubular films.

The apparatus further includes a heater, at least one second cooling device placed between the fourth and fifth pairs of pinch rollers, and winding rollers for each tubular film.

In another embodiment, a method for producing a plurality of bi-oriented, heat-shrinkable thermoplastic tubular films at once is provided. The method includes extruding molten thermoplastic resins through a plurality of annular dies to form a plurality of melt-plasticized thermoplastic primary tubes, cooling the plurality of primary tubes thereby solidifying each primary tube, transferring the solidified primary tubes to a heat source through a first set of pinch rollers, passing the solidified primary tubes between a second pinch roller, and a separate third pinch roller for each of the solidified primary tubes, while introducing air to the interior of each solidified primary tube and while blocking air flow along the interior of the solidified primary tubes, thereby forming an entrapped air bubble in each of the solidified primary tubes between the second and third pinch rollers, causing the solidified primary tubes to stretch circumferentially about the entrapped air, and simultaneously with the circumferential stretching, the solidified primary tubes being stretched in a machine direction by applying different pinch roller speeds to produce bi-oriented tubular films having a first diameter.

The method further includes cooling the bi-oriented tubular films with cool air coming from at least one cooling device situated prior to the third pinch roller to form a plurality of cooled bi-oriented tubular films, annealing the plurality of cooled bi-oriented tubular films at an elevated temperature by re-inflating the cooled bi-oriented tubular films between a fourth pinch roller, and a separate fifth pinch roller for each of the cooled bi-oriented tubular films, while introducing air to the interior of each cooled bi-oriented tubular film and while blocking air flow along the interior of the cooled bi-oriented tubular films, thereby biaxially relaxing each cooled bi-oriented tubular film simultaneously in a circumferential direction and a machine direction by applying different pinch roller speeds to form a plurality of biaxially relaxed films having a second diameter, the second diameter being smaller than the first diameter, and cooling the plurality of biaxially relaxed films, thereby producing biaxially oriented, heat-shrinkable thermoplastic tubular films.

In one aspect of the application the thermoplastic films are monolayer films. In another aspect, the thermoplastic films are multilayer films.

### BRIEF DESCRIPTION OF THE FIGURES

FIG. 1 shows a block diagram of an apparatus system for producing a plurality of bi-oriented, heat-shrinkable thermoplastic tubular films according to the present application.

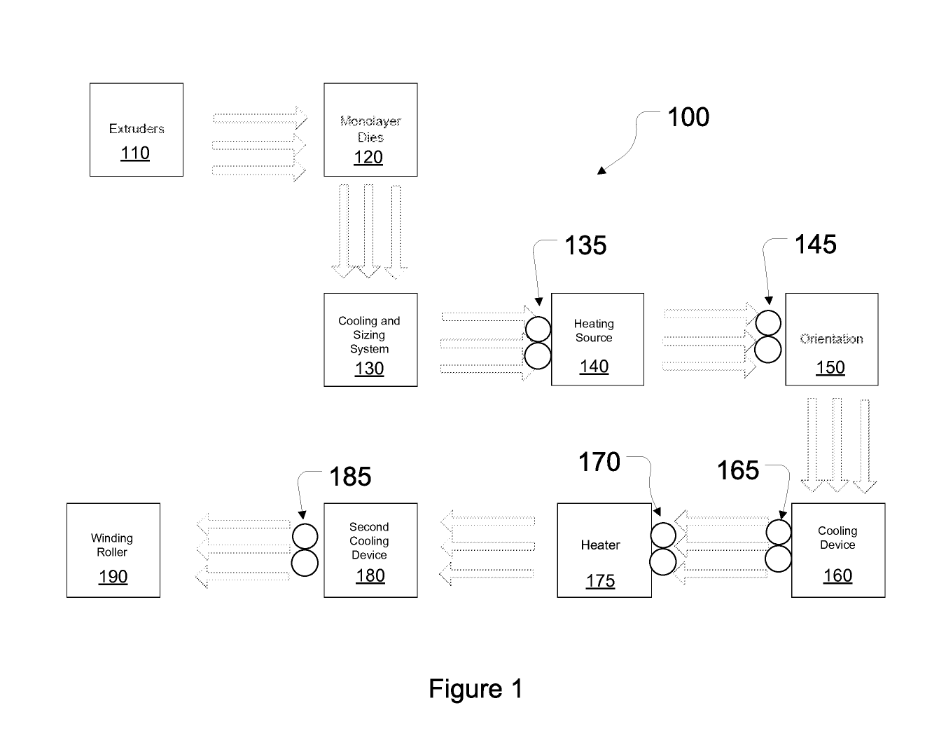

### DETAILED DESCRIPTION

The present application provides a relatively simple process and film which achieves a high degree of performance in providing a dimensionally stable film of uniform diameter, which is suitable for shirring, stuffing, cooking, and general manufacture of sausages having an excellent cooking yield, and a tight wrinkle-free appearance without requiring an after-shrinking step.

In one embodiment, the casing may be made by a continuous process in which a seamless tube is coextruded through an annular die, cooled below the melting points of each layer with water, biaxially stretch oriented, and annealed at an elevated temperature to dimensionally stabilize the seamless tubular film.

In one aspect, a method for producing a plurality of bi-oriented, heat-shrinkable thermoplastic tubular films at once is provided. The method includes extruding molten thermoplastic resins through a plurality of annular dies to form a plurality of melt-plasticized thermoplastic primary tubes, cooling the plurality of primary tubes thereby solidifying each primary tube, and transferring the solidified primary tubes to a heat source to bring the tubes to a draw temperature. As defined herein, the term draw temperature means just below the melting point temperature at which the tubes are stretchable or elastic. Thereafter, the heated solidified primary tubes are passed between a second pinch roller, and a separate third pinch roller for each of the solidified primary tubes, while introducing air to the interior of each solidified primary tube and while blocking air flow along the interior of the solidified primary tubes, thereby forming an entrapped air bubble in each of the solidified primary tubes between the second and third pinch rollers, causing the solidified primary tubes to stretch radially or circumferentially about the entrapped air in a transverse direction, and pulled or stretched in the machine direction, preferably simultaneously such that expansion occurs in both directions. The solidified primary tubes are being stretched in a machine direction by applying different pinch roller speeds to produce bi-oriented tubular films having a first diameter.

The method further includes cooling the bi-oriented tubular films with cool air, preferably at a temperature range of 40-60° F. (4.5-16° C.), coming from at least one cooling device situated prior to the third pinch roller to form a plurality of cooled bi-oriented tubular films. Preferably the cool air is blown in a generally upward direction, toward the radially extended portion of the tubing. The plurality of cooled bi-oriented tubular films is then annealed to dimensionally stabilize the film. Annealing occurs at an elevated temperature by re-inflating the cooled bi-oriented tubular films between a fourth pinch roller, and a separate fifth pinch roller for each of the cooled bi-oriented tubular films, while introducing air to the interior of each cooled bi-oriented tubular film and while blocking air flow along the interior of the cooled bi-oriented tubular films, thereby biaxially relaxing each cooled bi-oriented tubular film simultaneously in a radial or circumferential direction and a machine direction by applying different pinch roller speeds to form a plurality of biaxially relaxed films having a second diameter, the second diameter being smaller than the first diameter, and cooling the plurality of biaxially relaxed films, thereby producing biaxially oriented, heat-shrinkable thermoplastic tubular films.

The method may be used to prepare a heat shrinkable, biaxially stretched, multilayer, thermoplastic, polymeric flexible film of any suitable thickness such as the one described in U.S. Provisional application No. 60/961,620 (incorporated by reference in its entirety) which provides a beneficial combination of properties including ease of shirring and stuffing with low cost, good mechanical strength, good adhesion, and good oxygen and water barrier properties. Suitable examples of other thermoplastic films are described in U.S. Pat. No. 5,549,943, which is herein incorporated by reference in its entirety.

In another embodiment, an apparatus 100 for making a plurality of biaxially oriented, heat-shrinkable thermoplastic tubular films at once is described. The films may be monolayer or multilayer. The apparatus 100 includes at least one extruder 110 comprising a plurality of annular dies 120 for extruding a molten thermoplastic resin to form a plurality of molten plastic tubes.

The plurality of molten plastic tubes are then sent through a system 130 for cooling and solidifying the plurality of molten plastic tubes to form a plurality of solid tubes. The system 130 may be a water-quenching system, for example.

A heat source 140, such as a warm water bath, an infrared system, or steam, for example, is applied to the plurality of solid tubes to warm them. A first pair of pinch rollers 135 guides the plurality of solid tubes into the heat source 140. A second pair of pinch rollers 145 then pulls the plurality of solid tubes forward towards a third set of pinch rollers 165. The third set of pinch rollers 165 includes a separate set for each of the solid tubes. While the solid tubes are pulled between the second 145 and third 165 pinch rollers in an orientation stage 150, air is introduced into each of the solid tubes by a nozzle or valve, for example, and the third set of pinch rollers 165 is closed off the to entrap the air in a length of the solid tubes. Air flow is blocked along the interior of the solidified primary tubes. Thus, the tubes are biaxially stretched simultaneously in each of a machine direction (MD) and transverse direction (TD) to form a plurality of bi-oriented tubular films having a first diameter. The tubes are stretched by applying different pinch roller speeds to the second 145 and third set 165 of pinch rollers. For example, the third set of pinch rollers 165 may spin faster than the second set of pinch rollers 145 to stretch the tubes in the machine direction.

At least one first cooling device 160 placed between the second 145 and third 165 pairs of pinch rollers to cool the plurality of bi-oriented tubular films with cool air to form a plurality of cooled bi-oriented tubular films. The cooling device 160 may include, for example, a cooling air ring.

Next, the plurality of cooled bi-oriented tubular films undergo an annealing process. The plurality of films are sent through a fourth pair of pinch rollers 170 which pull the films toward a fifth 185 set of pinch rollers. The fifth set of pinch rollers 185 includes a separate set for each of the films. While the films are pulled towards the fifth set of pinch rollers 185, air is introduced into each of the cooled bi-oriented tubular films by a nozzle or valve, for example, while the fifth set of pinch rollers 185 are closed off to entrap the air in a length of the cooled bi-oriented tubular films, and air flow is blocked along the interior of the cooled bi-oriented tubular films. Thus, each film is biaxially relaxed simultaneously in each of a machine direction (MD) and transverse direction (TD) to form a plurality of tubular films having a second diameter. The second diameter is smaller than the first diameter. The films are relaxed by applying different pinch roller speeds to the fourth and fifth set of pinch rollers. For example, the fifth set of pinch rollers 185 may spin slower than the fourth set of pinch rollers 170 to relax the tubes in both the machine direction and the transverse direction.

A heater 175 is used to heat treat the plurality of tubular films during the relaxation in order to size the plurality of tubular films. At least one second cooling device 180 is placed between the fourth and fifth pairs of pinch rollers 170, 185 to cool the relaxed plurality of tubular films with cool air. The second cooling device 180 may be a cooling air ring, for example.

Finally, winding rollers 190 for each tubular film are used to wind up the tubular films so they are packaged and ready for use.

1. An apparatus for making a plurality of biaxially oriented, heat-shrinkable thermoplastic tubular films comprising:
at least one extruder comprising a plurality of annular dies for extruding a molten thermoplastic resin to form a plurality of molten plastic tubes;
a system for cooling and solidifying the plurality of molten plastic tubes to form a plurality of solid tubes;
a heat source;
a first pair of pinch rollers for guiding the plurality of solid tubes into the heat source to warm the plurality of solid tubes;
a second pair of pinch rollers;
a third set of pinch rollers for each of the solid tubes, wherein the second pair of pinch rollers pull the plurality of solid tubes forward towards the third set of pinch rollers, while introducing air into each of the solid tubes and then closing off the third set of pinch rollers to entrap the air in a length of the solid tubes, thereby biaxially stretching each tube simultaneously in each of a machine direction (MD) and transverse direction (TD) to form a plurality of bi-oriented tubular films having a first diameter;
at least one first cooling device placed between the second and third pairs of pinch rollers to cool the plurality of bi-oriented tubular films with cool air to form a plurality of cooled bi-oriented tubular films;
a fourth pair of pinch rollers;
a fifth set of pinch rollers for each of the cooled bi-oriented tubular films, wherein the fourth pair of pinch rollers pull the cooled bi-oriented tubular films forward towards the fifth set of pinch rollers, while introducing air into each of the cooled bi-oriented tubular films and then closing off the fifth set of pinch rollers to entrap the air in a length of the cooled bi-oriented tubular films, thereby biaxially relaxing each film simultaneously in each of a machine direction (MD) and transverse direction (TD) to form a plurality of tubular films having a second diameter, the second diameter being smaller than the first diameter;
a heater to heat treat the plurality of tubular films during the relaxation in order to size the plurality of tubular films
at least one second cooling device placed between the fourth and fifth pairs of pinch rollers to cool the relaxed plurality of tubular films with cool air; and
a winding roller for each tubular film for winding up the tubular films.

2. The apparatus of claim 1 wherein the plurality of tubular films is monolayer.

3. The apparatus of claim 1 wherein the plurality of tubular films is multilayer.

4. The apparatus of claim 1 wherein the system for cooling and solidifying is a water-quenching system.

5. The apparatus of claim 1 wherein the heat source is a warm water bath.

6. The apparatus of claim 1 wherein the air is introduced into the solid tubes by a nozzle or valve.

7. The apparatus of claim 1 wherein the third set of pinch rollers spin faster than the second set of pinch rollers to stretch the tubes in the machine direction.

8. The apparatus of claim 1 wherein the at least one first cooling device is a cooling air ring.

9. The apparatus of claim 1 wherein the air is introduced into the cooled bi-oriented tubular films by a nozzle or valve.

10. The apparatus of claim 1 wherein the fifth set of pinch rollers spin slower than the fourth set of pinch rollers to relax the tubes in both the machine direction and the transverse direction.

11. The apparatus of claim 1 wherein the second cooling device is a cooling air ring.
